(19) United States
(12) Patent Application Publication
(10) Pub. No.: US 2007/0265386 A1
(43) Pub. Date: Nov. 15, 2007

(54) Novel Inverse Latex with a Low Content of Monomer Comprising a Strong Acid Functional Group and Use in the Manufacture of Topical Compositions

(76) Inventors: Paul Mallo, Croissy-Sur-Seine (FR); Olivier Braun, Castres (FR)

Correspondence Address: YOUNG & THOMPSON, 745 SOUTH 23RD STREET, 2ND FLOOR, ARLINGTON, VA, 22202, US

(21) Appl. No.: 11/631,404

(22) PCT Filed: Jul. 8, 2005
(86) PCT No.: PCT/EP05/53289

§ 371 Date: Mar. 2, 2007

(30) Foreign Application Priority Data
Jul. 15, 2004 (FR) 0451532

(51) Int. Cl. C08L 33/26

(52) U.S. Cl. 524/457

(57) ABSTRACT

Composition comprising an oil phase, an aqueous phase, at least one emulsifying agent of water-in-oil (W/O) type and at least one emulsifying agent of oil-in-water (O/W) type, comprising from 20% to 70% by weight and preferably from 25% to 50% by weight of a crosslinked anionic polyelectrolyte, characterized in that the said polyelectrolyte is a copolymer of partially or completely salified 2-methyl-2-[(1-oxo-2-propenyl)amino]-1-propanesulphonic acid polymerized with at least one neutral monomer and with optionally at least one monomer, having a weak acid functional group in which the molar proportion of partly or completely salified 2-methyl-2-[(1-oxo-2-propenyl)amino]-1-propanesulphonic acid monomer is less than 30% and is greater than or equal to 1%. Applications in cosmetics.

The present application relates to novel polymers in the form of inverse latexes or of powders, to their process of preparation and to their application in the manufacture of cosmetic, dermopharmaceutical or pharmaceutical preparations.

Texturizing agents are frequently used in the manufacture of formulations intended for caring for or making up the skin or mucous membranes or else in application to substrates such as paper or textiles. Their main role is to improve the sensory and rheological properties of the formulations in which they are incorporated or of the substrates to which they are applied. Examples of texturizing agents used in cosmetics include powders formed of poly(methyl methacrylate) (Micropearl™), powders formed of polyamide (Nylon™), powders formed of silicone (DC9506™, Polytrap™) or modified starches (Dry Flo™). Some of these powders provide the user with a sensation of softness on spreading and a long-lasting powdered feel; others inhibit the greasy sensation experienced on spreading and produce a mattifying effect over a long period of time.

Some amino acid derivatives, such as N-lauroyllysine, are sometimes added to make-up formulations in order to combine the effects of softness on application and of good hold on the skin. This effect can also be obtained by virtue of a surface treatment of the powders with various compounds, including amino acids.

In some cases, fibres of natural origin, such as cellulose or cotton fibres, or synthetic fibres, such as polyethylene, teflon or polyester fibres, are also added to the formulations in order to modify the rheological characteristics thereof, to improve the homogeneity in their distribution over the surface to be coated and to improve their hold on this same surface.

Certain fillers, such as talc, mica, sericite or composite fillers, are also used to adjust the lubricating properties of the formulation and to facilitate the flowing or the spreading over the substrate.

Other types of pigment fillers, such as titanium oxide, zinc oxide or iron oxides, can also be incorporated in these formulations in order to adjust the transparency or the colour on application thereof while influencing their final texture.

These powders are generally well suited to the manufacture of formulations of free powder or compact powder type or of formulations with a continuous fatty phase, such as water-in-oil emulsions, water-in-silicone oil emulsions, sticks and other compact formulations.

In contrast, they are often difficult to employ in media with a continuous aqueous phase, such as lotions, gels, cream gels or emulsions of the oil-in-water type. It is then necessary to carry out specific and expensive preliminary studies for each powder and each type of formulation in order to obtain both good dispersion of the powder and good stability of the formulation.

The formulator is then often obliged to use either hydrophilic microporous microspheres of Micropearl™ type in combination with stabilizing agents or powders treated at the surface in order to improve the compatibility with the other ingredients of the formulation. However, in the latter case, the appropriate treatment is specific to the formulation chosen, which, furthermore, does not exempt the formulator from a study of stability within the formulation of the treated powder chosen. Finally, this final solution is generally unsuitable for formulations of aqueous continuous phase type, whether in the absence or in the presence of a low level of fatty phase.

For this reason, in the context of its research into cosmetic formulations, the Applicant Company has sought to develop novel rheology-modifying agents which are easy to employ, equally well in solid formulations of free powder or compacted powder type as in formulations with a continuous fatty phase or as in formulations with a continuous aqueous phase comprising or not comprising a low level of fatty phase.

A subject-matter of the invention is a composition in the form of an inverse latex, comprising an oil phase, an aqueous phase, at least one emulsifying agent of water-in-oil (W/O) type and at least one emulsifying agent of oil-in-water (O/W) type, comprising from 20% to 70% by weight and preferably from 25% to 50% by weight of a crosslinked anionic polyelectrolyte, characterized in that the said polyelectrolyte is a copolymer of partially or completely salified 2-methyl-2-[(1-oxo-2-propenyl)amino]-1-propanesulphonic acid polymerized with at least one neutral monomer and with optionally at least one monomer having a weak acid functional group, in which the molar proportion of partially or completely salified 2-methyl-2-[(1-oxo-2-propenyl)amino]-1-propanesulphonic acid monomer is less than 30% and is greater than or equal to 1%.

The term “emulsifying agent of the water-in-oil type” denotes surface-active agents having an HLB value which is sufficiently low to provide water-in-oil emulsions, such as surfactant polymers of the polyethylene glycol/poly(hydroxystearic acid) block copolymer type, sold under the Hypermer™ or Simaline™ names, or such as sorbitan esters, for example the sorbitan monooleate sold by the Applicant Company under the name Montane™ 80, the sorbitan isostearate sold by the Applicant Company under the name Montane™ 70, the pentaethoxylated sorbitan oleate ethoxylated with 5 mol of ethylene oxide (5 EO) sold by the Applicant Company under the name Montane™ 81, the diethoxylated (2 EO) oleocetyl alcohol sold by the Applicant Company under the name Simulsol™ OC 72 or the sorbitan sesquioleate sold by the Applicant Company under the name Montane™ 83.

The term “emulsifying agent of the oil-in-water type” denotes surface-active agents having an HLB value which is sufficiently high to provide oil-in-water emulsions, such as polyethoxylated sorbitan esters, for example the sorbitan oleate ethoxylated with 20 mol of ethylene oxide (20 EO) sold by the Applicant Company under the name Montanox™ 80, the polyethoxylated castor oil with 40 mol of ethylene oxide (40 EO) sold by the Applicant Company under the name Simulsol™ OL 50, the polyethoxylated sorbitan laurate ethoxylated with 20 mol of ethylene oxide (20 EO) sold by the Applicant Company under the name Montanox™ 20, the polyethoxylated sorbitan trioleate ethoxylated with 25 mol sold of ethylene oxide (25 EO) by the Applicant Company under the name Montanox™ 85, the eptaethoxylated lauryl alcohol ethoxylated with 7 mol of ethylene oxide (7 EO) sold by the Applicant Company under the name Simulsol™ P7, the decaethoxylated (10 EO) oleocetyl alcohol sold by the Applicant Company under the name Simulsol™ OC 710 or the polyethoxylated sorbitan hexaoleates sold under the names G-1086™ and G-1096™.

The term “crosslinked anionic polyelectrolyte” denotes a nonlinear polymer which is provided in the form of a water-insoluble but water-swellable three-dimensional network and which thus results in the production of a chemical gel.

The term “neutral monomer” denotes in particular a monomer chosen from acrylamide, methacrylamide, dimethylacrylamide, 2-hydroxyethyl acrylate, 2,3-dihydroxypropyl acrylate, 2-hydroxyethyl methacrylate, 2,3-dihydroxypropyl methacrylate, diacetone acrylamide or an ethoxylated derivative, with a molecular weight of between 400 and 1000, of each of these esters.

The term “monomer with a weak acid functional group” denotes in particular carboxylic acids and more particularly acrylic acid, methacrylic acid, itaconic acid, maleic acid or 3-methyl-3-[(1-oxo-2-propenyl)amino]butanoic acid, the said acids being partially or completely salified.

The term “partially or completely salified” means, for 2-methyl-2-[(1-oxo-2-propenyl)amino]-1-propanesulphonic acid or for the monomers with a weak acid functional group, in particular, either of alkali metal salt, such as, for example, the sodium salt or the potassium salt, or of an ammonium salt, or of salt of an aminoalcohol, such as, for example, the monoethanolamine salt, or of salt of an amino acid, such as, for example, the lysine salt.

In the context of the present invention, the term “copolymer” should be understood as also denoting terpolymers or tetrapolymers, provided that they comprise, as monomers, at least 2-methyl-2-[(1-oxo-2-propenyl)amino]-1-propanesulphonic acid and at least one neutral monomer.

A more particular subject-matter of the invention is a composition as defined above in which the anionic polyelectrolyte is chosen from:

copolymers of acrylamide and of 2-methyl-2-[(1-oxo-2-propenyl)amino]-1-propanesulphonic acid which are partially or completely salified in the sodium salt form, and

terpolymers of 2-methyl-2-[(1-oxo-2-propenyl)amino]-1-propanesulphonic acid partially or completely salified in the sodium salt form, of acrylic acid partially or completely salified in the sodium salt form, and of acrylamide.

A more particular subject-matter of the invention is a composition as defined above, characterized in that the anionic polyelectrolyte is crosslinked with a diethylene or polyethylene compound in the molar proportion, expressed with respect to the monomers employed, of 0.005% to 1%, preferably of 0.01% to 0.5% and more particularly of 0.01% to 0.25%.

The crosslinking agent as defined above is preferably chosen from ethylene glycol dimethacrylate, diallyloxyacetic acid or one of its salts, such as sodium diallyloxyacetate, ethylene glycol diacrylate, diallylurea, triallylamine, trimethylolpropane triacrylate or methylenebis(acrylamide), or a mixture of these compounds.

A more particular subject-matter of the invention is also a composition as defined above in which the anionic polyelectrolyte exhibits a molar proportion of 2-methyl-2-[(1-oxo-2-propenyl)amino]-1-propanesulphonic acid monomer of greater than or equal to 2% and of less than or equal to 20%.

The self-invertible inverse latex which is a subject-matter of the present invention generally comprises from 2.5% to 15% by weight and preferably from 4% to 9% by weight of emulsifying agents, among which from 20% to 50%, in particular from 25% to 40%, of the total weight of the emulsifying agents present are of the water-in-oil (W/O) type and among which from 80% to 50%, in particular from 75% to 60%, of the total weight of the emulsifying agents are of the oil-in-water (O/W) type.

In the self-invertible inverse latex which is a subject-matter of the present invention, the oil phase generally represents from 15% to 40% and preferably from 20% to 25% of its total weight.

This oil phase is generally composed either of a commercial mineral oil comprising saturated hydrocarbons, such as paraffins, isoparaffins or cycloparaffins, exhibiting, at ambient temperature, a density between 0.7 and 0.9 and a boiling point of greater than 180° C., such as, for example, Isopar™ L, Isopar™ M, Exxsol™ D 100 S or Marcol™ 52, sold by Exxon Chemical, isohexadecane or isododecane, or of a vegetable oil, or of glycerol esters, such as Softenol™ 3108, Softenol™ 3178, Softenol™ 3100, Softenol™ 3107 or Softenol™ 3118, or of fatty acid esters, or of a synthetic oil, or of a mixture of several of these oils.

According to a preferred aspect of the present invention, the oil phase is composed of Marcol™ 52, of squalane, of hydrogenated polyisobutene, of octyl palmitate, of isostearyl isostearate, of isododecane or of isohexadecane; isohexadecane, which is identified in Chemical Abstracts by the number RN=93685-80-4, is a mixture of C₁₂, C₁₆ and C₂₀ isoparaffins comprising at least 97% of C₁₆ isoparaffins, among which the main constituent is 2,2,4,4,6,8,8-heptamethylnonane (RN=4390-04-9). It is sold in France by Bayer. Marcol™ 52 is a commercial oil meeting the definition of liquid petrolatums of the French Pharmacopoeia. It is a white mineral oil in accordance with the FDA regulations 21 CFR 172.878 and CFR 178.3620 (a) and it is listed in the United States Pharmacopoeia, US XXIII (1995), and in the European Pharmacopoeia (1993). Softenol™ 3819 is a mixture of triglycerides of fatty acids comprising from 6 to 10 carbon atoms. Softenol™ 3108 is a mixture of triglycerides of fatty acids comprising from 8 to 10 carbon atoms. Softenol™ 3178 is a mixture of triglycerides of fatty acids comprising from 8 to 18 carbon atoms. Softenol™ 3100 is a mixture of triglycerides of fatty acids comprising from 12 to 18 carbon atoms. Softenol™ 3107 is a mixture of triglycerides of fatty acids comprising 7 carbon atoms. Softenol™ 3114 is a mixture of triglycerides of fatty acids comprising 14 carbon atoms. Softenol™ 3118 is a mixture of triglycerides of fatty acids comprising 18 carbon atoms.

The self-invertible inverse latexes employed in the present invention generally comprise between 20% and 50% of water. They can also comprise various additives, such as complexing agents, chain-transfer agents or chain-limiting agents.

According to another aspect of the present invention, a subject-matter of the latter is a process for the preparation of the composition as defined above, characterized in that:

a) an aqueous solution comprising the monomers and the optional additives is emulsified in an oil phase in the presence of one or more emulsifying agents of water-in-oil type,

b) the polymerization reaction is initiated by introduction into the emulsion formed in a) of an initiator of free radicals and then the reaction is allowed to take place,

c) when the polymerization reaction is finished, one or more emulsifying agents of oil-in-water type is/are introduced at a temperature of less than 50° C.

According to an alternative form of this process, the reaction medium resulting from stage b) is concentrated by distillation before carrying out stage c).

According to a preferred implementation of the process as defined above, the polymerization reaction is initiated by an oxidation/reduction couple, such as the cumene hydroperoxide/sodium metabisulphite couple, at a temperature of less than or equal to 10° C., and is then carried out either quasi-adiabatically, up to a temperature of greater than or equal to 40° C., more particularly of greater than or equal to 50° C., or by controlling the change in the temperature.

Another subject-matter of the invention is a polymer powder, characterized in that it is obtained either by azeotropic distillation or by precipitation or by atomization of the inverse latex as defined above.

The azeotropic distillation, precipitation or atomization operations are carried out conventionally by the expert in polymers and their operating conditions are described in the literature.

Another subject-matter of the invention is the use of an inverse latex as defined above or of the polymer powder as defined above in preparing a cosmetic, dermopharmaceutical or pharmaceutical topical composition and the said cosmetic, dermopharmaceutical or pharmaceutical topical compositions comprising them.

Solid topical compositions based on cosmetically or pharmaceutically acceptable powders or fibres or emulsions with a continuous fatty phase comprising the said powders or fibres are more particularly targeted as cosmetic, dermopharmaceutical or pharmaceutical topical composition for the use of the composition according to the invention.

The term “cosmetically or pharmaceutically acceptable powder” denotes in particular inorganic or organic and hydrophilic or hydrophobic powders of synthetic or natural origin, with a mean diameter of between approximately 0.01 μm and approximately 250 μm and preferably between 1 and 50 μm, which may or may not be micronized, and of all forms, in particular in the fibre form, in the lamellar form or in the spherical form, which have optionally been subjected to a surface treatment. Examples are copolymers of acrylic acid and methacrylic acid or of their esters, starches, silicas, calcium, magnesium or barium silicates, calcium phosphate, boron nitride, lauroyllysine, silicone resin powders, calcium or magnesium carbonates, titanium or zinc or cerium oxides, iron oxides and other inorganic or organic pigments, or the mixtures of these powders.

Examples of fibres are natural fibres, such as cotton, cellulose or chitosan fibres, or synthetic fibres, such as polyamide fibres, for example Nylon™ fibres, Rayon™ fibres, Viscose™ fibres, cellulose acetate fibres, poly(p-phenylene terephthalamide) fibres, such as Kevlar™ fibres, polyethylene or polypropylene fibres, glass fibres, carbon fibres, Teflon™ fibres, polyester fibres, poly(vinyl chloride) fibres, poly(vinyl alcohol) fibres, polyacrylonitrile fibres, polyurethane fibres or poly(ethylene phthalate) fibres. Examples of powders in lamellar form are talcs, micas, titanium oxide-coated mica or sericite. Examples of powders in the spherical form are poly(methyl methacrylate)s, often denoted in the literature by PMMA, which are formed of microporous microspheres with a specific surface of greater than or equal to 0.5 m² per gram, such as those sold under the names Micropearl™ M305, Micropearl™ M100, Micropearl™ M201 or Micropearl™ M310; copolymers or terpolymers of methyl methacrylate with one or more monomers chosen from butyl acrylate, 1-methylpropyl acrylate, 2-methylpropyl acrylate, 1,1-dimethylethyl acrylate, butyl methacrylate, 1-methylpropyl methacrylate, 2-methylpropyl methacrylate or 1,1-dimethylethyl methacrylate, such as those sold under the Microsphere™ name; silica microspheres, such as those sold under the Silica Beads™ or Polytrap™ names; hollow microspheres made of thermoplastic, such as polyethylenes, polystyrenes, polyacrylonitriles or polyamides, such as those sold under the Orgasol™ name, or made of polyesters, such as those sold under the Expancel™ name; microcapsules made of organic or inorganic material, such as those sold under the Macrolite™ name.

Another subject-matter of the invention is a concentrate intended for the preparation of topical compositions essentially comprising a mixture comprising:
from 5% to 80% by weight of at least one composition as defined above, and
from 20% to 95% of a cosmetically or pharmaceutically acceptable powder.

According to a first specific aspect, the concentrate as defined above comprises at least 50% by weight of powder as defined above.

According to a second specific aspect, the concentrate as defined above is in the form of a homogeneous powder.

Another subject-matter of the invention is a process for the preparation of the concentrate as defined above by simple mixing of the self-invertible inverse latex with the powder.

The concentrates which are a subject-matter of the present invention are used as texturizing agents for cosmetic or pharmaceutical formulations, whether liquid or solid formulations. Their physical and sensory properties, whether relating to their very soft feel, improved in comparison with the powder used alone, or to their excellent adherence to the skin, better than that of the powder used alone, and their ability to be homogeneously suspended in the final formulations render them particularly appropriate for use in solid formulations, such as foundations, make-up powders, mascaras or lipsticks.

In the case of their use in liquid formulations, they can in particular be emulsions, lotions or gels and more particularly sprayable formulations or else solutions impregnated on fabrics or paper and more particularly on wipes or on complexion-correcting papers.

The following examples illustrate the invention without, however, limiting it.

### EXAMPLE 1

### Copolymer of 2-methyl-2-[(1-oxo-2-propenyl)amino]-1-propanesulphonic acid (AMPS) and of acrylamide (AM) partially or completely salified in the sodium salt form and crosslinked with triallylamine (AMPS/AM=5/95)

The following are charged to a beaker with stirring:
350 g of deionized water,
69.2 g of a commercial 55% by weight solution of the sodium salt of 2-methyl-2-[(1-oxo-2-propenyl)amino]-1-propanesulphonic acid,
236.1 g of acrylamide,
0.45 g of a commercial 40% sodium diethylenetriaminepentaacetate solution, and

0.36 g of triallyalmine.

The pH of the aqueous phase described above is adjusted to 3.5 and the amount of aqueous phase is made up to 680 g by addition of deionized water.

At the same time, an organic phase is prepared by successively introducing, into a stirred beaker:
220 g of Exxsol™ D100,
27.5 g of Montane™ 80 VG (sorbitan oleate, sold by Seppic),
and 0.1 g of azobisisobutyronitrile.

The aqueous phase is gradually introduced into the organic phase and is then subjected to vigorous mechanical stirring using a device of UltraTurrax™ type sold by IKA.

The emulsion obtained is then transferred into a polymerization reactor. The emulsion is subjected to significant sparging with nitrogen, so as to remove the oxygen, and is cooled to approximately 8-10° C.

5 ml of a solution comprising 0.42% (by weight) of cumene hydroperoxide in isohexadecane are then introduced.

After a time sufficient for good homogenization of the solution, an aqueous sodium metabisulphite solution (0.2 g in 100 ml of water) is then introduced at the rate of 0.5 ml/minute. The introduction is carried out over approximately 60 minutes.

During this introduction, the temperature in the polymerization reactor is allowed to rise to the final polymerization temperature. The reaction medium is then maintained at this temperature for approximately 90 minutes. The combined mixture is cooled to a temperature of approximately 35° C. and 35 g of heptaethoxylated (7 EO) lauryl alcohol are slowly introduced.

Filtration is carried out and the inverse latex thus obtained is collected.

### EXAMPLE 2

### Copolymer of 2-methyl-2-[(1-oxo-2-propenyl)-amino]-1-propanesulphonic acid (AMPS) and of acrylamide (AM) partially or completely salified in the sodium salt form and crosslinked with triallylamine (AMPS/AM=15/85)

The following are charged to a beaker with stirring:
270 g of deionized water,
218.6 g of a commercial 55% by weight solution of the sodium salt of 2-methyl-2-[(1-oxo-2-propenyl)amino]-1-propanesulphonic acid,
181.0 g of acrylamide,
0.45 g of a commercial 40% sodium diethylenetriaminepentaacetate solution, and

0.36 g of triallyalmine.

The pH of the aqueous phase described above is adjusted to 3.5 and the amount of aqueous phase is made up to 680 g by addition of deionized water.

At the same time, an organic phase is prepared by successively introducing, into a stirred beaker:
220 g of Exxsol™ D100,
27.5 g of Montane™ 80 VG (sorbitan oleate, sold by Seppic),
and 0.1 g of azobisisobutyronitrile.

The aqueous phase is gradually introduced into the organic phase and is then subjected to vigorous mechanical stirring using a device of UltraTurrax™ type sold by IKA.

The emulsion obtained is then transferred into a polymerization reactor. The emulsion is subjected to significant sparging with nitrogen, so as to remove the oxygen, and is cooled to approximately 8-10° C.

5 ml of a solution comprising 0.42% (by weight) of cumene hydroperoxide in isohexadecane are then introduced.

After a time sufficient for good homogenization of the solution, an aqueous sodium metabisulphite solution (0.2 g in 100 ml of water) is then introduced at the rate of 0.5 ml/minute. The introduction is carried out over approximately 60 minutes.

During this introduction, the temperature in the polymerization reactor is allowed to rise to the final polymerization temperature. The reaction medium is then maintained at this temperature for approximately 90 minutes. The combined mixture is cooled to a temperature of approximately 35° C. and 35 g of heptaethoxylated (7 EO) lauryl alcohol are slowly introduced. Filtration is carried out and the inverse latex thus obtained is collected.

### EXAMPLE 3

### Preparation of an Inverse Latex of terpolymer of 2-methyl-2-[(1-oxo-2-propenyl)amino]-1-propanesulphonic acid (AMPS), of acrylic acid (AA), which are partially or completely salified in the sodium salt form, and of acrylamide (AM) crosslinked with triallylamine (AMPS/AA/AM=10/10/80)

An organic phase is prepared by introducing 27.5 g of Montane™ 80 into 220 g of Exxsol™ D100 sold by Exxon Chemicals and composed of a mixture of cycloparaffin and paraffin hydrocarbons. 0.1 g of azobisisobutyronitrile is added thereto.

At the same time, an aqueous phase is prepared by introducing:
270 g of water,
199.0 g of acrylamide,
145.7 g of a commercial 55% solution of the sodium salt of 2-methyl-2-[(1-oxo-2-propenyl)amino]-1-propanesulphonic acid,
25.0 g of acrylic acid,
20 g of a 50% sodium hydroxide solution,
0.18 g of triallylamine, and
0.45 g of a commercial 40% sodium diethylenetriaminepentaacetate solution.

The pH of the aqueous phase is adjusted to 5.3 by adding the required amount of 2-acrylamido-2-methylpropanesulphonic acid (approximately 3 g).

The total amount of aqueous phase is then adjusted to 680 g by addition of water.

The aqueous phase is subsequently dispersed with stirring in the oil phase and then subjected to the action of significant shearing using a turbine mixer of UltraTurrax™ or Silverson™ type. The inverse emulsion thus obtained is then subjected to sparging with nitrogen, so as to remove the dissolved oxygen. After having cooled the inverse emulsion to approximately 8/10° C., the polymerization reaction is initiated by addition of an oxidation/reduction couple, cumene hydroperoxide/sodium metabisulphite. The temperature rises to approximately 80° C. The polymerization reaction is subsequently allowed to continue until a temperature stationary phase is obtained, indicating the end of the reaction. The reaction medium is then maintained at this temperature, so as to remove the residual monomers. 35 g of ethoxylated lauryl alcohol comprising 7 moles are then added at approximately 35° C. Filtration is carried out and the inverse latex thus obtained is collected.

### EXAMPLE 4

### Preparation of an Inverse Latex of terpolymer of 2-methyl-2-[(1-oxo-2-propenyl)amino]-1-propanesulphonic acid (AMPS), of acrylic acid (AA), which are partially or completely salified in the sodium salt form, and of acrylamide (AM) crosslinked with triallylamine (AMPS/AA/AM=2/5/93)

An organic phase is prepared by introducing 27.5 g of Montane™ 80 into 220 g of Exxsol™ D100. 0.1 g of azobisisobutyronitrile is added thereto.

At the same time, an aqueous phase is prepared by introducing:
270 g of water,
231.0 g of acrylamide,
72.8 g of a commercial 55% solution of the sodium salt of 2-methyl-2-[(1-oxo-2-propenyl)amino]-1-propanesulphonic acid,
5.0 g of acrylic acid,
4 g of a 50% sodium hydroxide solution,
0.36 g of triallylamine, and
0.45 g of a commercial 40% sodium diethylenetriaminepentaacetate solution.

The pH of the aqueous phase is adjusted to 5.3 by adding the required amount of 2-acrylamido-2-methylpropanesulphonic acid (approximately 3 g). The total amount of aqueous phase is then adjusted to 680 g by addition of water. The aqueous phase is subsequently dispersed with stirring in the oil phase and then subjected to the action of significant shearing using a turbine mixer of UltraTurrax™ or Silverson™ type. The inverse emulsion thus obtained is then subjected to sparging with nitrogen, so as to remove the dissolved oxygen.

After having cooled the inverse emulsion to approximately 8/10° C., the polymerization reaction is initiated by addition of an oxidation/reduction couple, cumene hydroperoxide/sodium metabisulphite. The temperature rises to approximately 80° C. The polymerization reaction is subsequently allowed to continue until a temperature stationary phase is obtained, indicating the end of the reaction. The reaction medium is then maintained at this temperature, so as to remove the residual monomers. 35 g of ethoxylated lauryl alcohol comprising 7 moles are then added at approximately 35° C. Filtration is carried out and the inverse latex thus obtained is collected.

### EXAMPLE 5

### Suspending Properties—Stability of the Aqueous Dispersion

A concentrate according to the invention was prepared by mixing, by simple stirring, Micropearl™ M310 and the composition prepared in Example 2 in a 60/40 ratio by weight and then its properties were compared with those of Micropearl™ M310 alone.

To do this, aqueous dispersions of the concentrate according to the invention and of the control powder at 2% by weight in water were prepared by mechanical stirring with a deflocculating turbine mixer. It is then found that the concentrate according to the invention makes it possible to very simply formulate formulations with a noteworthy feel, an excellent stability on storage and a fully adjustable viscosity.

These concentrates can advantageously be used for all types of care or make-up formulations in a continuous aqueous phase alone, this being the case whether the starting powders are hydrophilic, such as Micropearl™ M305, or hydrophobic, such as Micropearl™ M310.

### EXAMPLE 6

### Stabilizing Effect in a Water-In-Silicone Emulsion

A series of emulsions in silicone oils was prepared on the basis of the following formulation:

Phase A:

| | | |
|---|---|---|
| DC5225C ™ | 20% | by weight |
| DC345 ™ | 10% | by weight |
| Sepicide ™ HB | 0.3% | by weight |
| Concentrate (Micropearl ™ M310 + composition | 5% | by weight |
| of Example 2 - | | |
| ratio by weight 8/2) | | |

Phase B

| | |
|---|---|
| Water | q.s. for 100% |
| Sepicide ™ CI | 0.2% by weight |
| Glycerol | 5% by weight |
| Sodium chloride | 2% by weight |

Manufacturing Method

The fatty phase A (comprising the fillers) and the aqueous phase B are weighed out separately and mixed using a spatula.

The aqueous phase is then introduced into the fatty phase, under an anchor stirrer, in several fractions; stirring is maintained for approximately 10 minutes and then the emulsion is passed into a die homogenizer (ALM™ die A180).

It is observed that the concentrate according to the invention significantly improves, without modification to the manufacturing process, the stability of the emulsions produced, even for a low percentage of powder, when this stability is compared with that of an emulsion in which the concentrate (Micropearl™ M310+ composition of Example 2—ratio of weight 8/2) is replaced with 5% by weight of Micropearl™ M310 alone.

### EXAMPLE 7

### Purifying Lotion for Greasy Skins

Formulation

Phase A

| Water | q.s. for 100% |
|---|---|
| Copper gluconate | 0.05% |
| Zinc gluconate | 0.15% |

Phase B

| | |
|---|---|
| Micropearl ™ M310 + composition | 3.50% |
| of Example 1 (75/25 by weight) | |

Phase C

| | |
|---|---|
| Sepicide ™ HB | 0.30% |
| Sepicide ™ LD | 0.80% |
| Fragrance | 0.10% |

Method

Phase A is prepared by dispersing the pulverulent compound in the water with stirring and then phases B and C are added to the gel while maintaining the stirring.

### EXAMPLE 8

### Powder-Comprising Fluid for Impregnation on Wipes

Formulation

Phase A

| | |
|---|---|
| Water | q.s. for 100% |
| Glycerol | 3.00% |
| Micropearl ™ M310 + composition | 2.4% |
| of Example 3 (60/40 by weight) | |

Phase B

| | |
|---|---|
| Sepicide ™ HB | 0.30% |
| Sepicide ™ LD | 0.80% |
| Fragrance | 0.10% |

Method

Phase A is prepared by dispersing the pulverulent compound in the water with stirring and then phase B is added to the gel while maintaining stirring.

### EXAMPLE 9

### Softness Sprayable Fluid

Formulation

Phase A

| | |
|---|---|
| Water | q.s. for 100% |
| Micropearl ™ M201 + composition | 5.00% |
| of Example 3 (80/20 by weight) | |

Phase B

| | |
|---|---|
| DC345 ™ | 2.00% |

Phase C

| | |
|---|---|
| Sepicide ™ HB | 0.30% |
| Sepicide ™ CI | 0.20% |
| Fragrance | 0.15% |
| Sensiva ™ SC50 | 0.50% |

Method

Phase A is prepared by dispersing the composition according to the invention in the water with stirring and then phases B and C are added to the gel while maintaining the stirring.

### EXAMPLE 10

### Aftersun Refreshing Gel

Formulation

Phase A

| | |
|---|---|
| 90° Ethanol | 20.00% |
| Menthol | 00.05% |

Phase B

| | |
|---|---|
| Aqua/water | q.s. for 100% |
| Micropearl ™ M201 + composition | 10.00% |
| of Example 4 (80/20 by weight) | |

Phase C

| | |
|---|---|
| Sepicalm ™ VG | 03.00% |
| Fragrance | 00.10% |
| Dye | q.s. |

Method

Phase A is prepared by dissolving the menthol in the ethanol.

Phase B is prepared by dispersing the composition according to the invention in the water with stirring and then, when the gel is homogeneous, phase C and then phase A are added to phase B.

### EXAMPLE 11

### Toning Body Care Composition

Formulation

Phase A

| | |
|---|---|
| Water | q.s. for 100% |
| Micropearl ™ 305 + composition | 8.50% |
| of Example 1 (80/20 by weight) | |

Phase B

| | |
|---|---|
| Lanol ™ 99 | 5.00% |
| Sepicalm ™ VG | 1.00% |
| Sepilift ™ DPHP | 1.00% |

Phase C

| | |
|---|---|
| Sepicide ™ HB | 0.30% |
| Sepicide ™ CI | 0.20% |
| Fragrance | 0.10% |

Method

The composition according to the invention is dispersed in the water with stirring.

Phase B is prepared by heating the ester to 70° C. and by then adding the Sepicalm™ VG and the Sepilift™ DPHP.

This phase B is added with stirring to phase A and then phase C is also added to the mixture thus formed.

### EXAMPLE 12

### Stimulating Care Composition

Formulation

Phase A

| Water | q.s. for 100% |
|---|---|
| Glycerol | 02.50% |
| Micropearl ™ M310 + composition | 15.00% |
| of Example 3 (80/20 by weight) | |
| Sepitonic ™ M3 | 01.00% |

Phase B

| | |
|---|---|
| Lanol ™ 99 | 05.00% |
| DC345 ™ | 02.50% |

Phase C

| | |
|---|---|
| Fragrance | 00.10% |
| Sepicide ™ HB | 00.30% |
| Sepicide ™ CI | 00.20% |

Method

The pulverulent compound is dispersed with stirring in the aqueous phase and then the fatty phase B is introduced into the aqueous phase A while maintaining the stirring. Phase C is added to the final gel.

### EXAMPLE 13

### Lipstick

Formulation

| | | |
|---|---|---|
| Phase A | Decyl oleate | 25.00% |
| | Titanium dioxide | 6.44% |
| | Yellow iron oxide | 3.04% |
| | Black iron oxide | 0.36% |
| | Dye “DC Red 7” | 0.78% |
| | Dye “FDC Yellow 6” | 0.70% |
| | Dye “FDC Blue 1” | 0.17% |

| | | |
|---|---|---|
| Phase B | Lanol ™ 99 | q.s. for 100% |
| | Ozokerite | 11.75% |
| | Cetyl ricinoleate | 10.00% |
| | Octyldodecanol | 8.12% |
| | Beeswax | 4.20% |
| | Triisostearyl trilinoleate | 5.00% |
| | Cetyl palmitate | 4.50% |
| | Carnauba wax (Copernicia cerifera) | 2.28% |
| | Sepilift ™ DPHP | 1.00% |
| | Micropearl ™ MHB + composition | 3.00% |
| | of Example 4 (65/35 by weight) | |

| | | |
|---|---|---|
| Phase C | Fragrance | 1.25% |
| | Tocopheryl acetate | 00.20% |

Method

Phase A is milled with a bead mill.

Phase B is melted at 85° C.-90° C. and then the premilled phase A is added with stirring. The mixture is stirred until completely dispersed.

Phase C is introduced with stirring. The paste is poured under hot conditions into the moulds.

### EXAMPLE 14

### Face Powder

Formulation

| | | |
|---|---|---|
| Phase A | Givobio ™ GCu | 0.50% |
| | Lipacide ™ C8G | 0.50% |
| | Lipacide ™ UG | 0.50% |
| | Composition of Example 1 | 2.00% |
| | Micropearl ™ MHB | 3.00% |
| | Mica | 50.00% |
| | Talc | 33.00% |
| | Dye “FDC Yellow 6 Lake” | 0.30% |
| | Dye “Ariabel Sienna” | 0.20% |

| | | |
|---|---|---|
| Phase B | Lanol ™ 99 | 5.00% |

| | | |
|---|---|---|
| Phase C | Dimethicone | 5.00% |

Method

All the powders (Phase A) are weighed out and are dry milled in a blade mill.

Phase B is added and the same milling time as for Phase A is repeated.

Phase C is added and the same milling operation as for Phase B is repeated.

The powder thus prepared is subsequently pressed into pots using a Kenwall™ manual compactor under a pressure of 80×10⁵ Pa.

### EXAMPLE 15

### Foundation

Formulation

Phase A

| | |
|---|---|
| Water | 9.50% |
| Butylene glycol | 2.00% |
| PEG-400 | 2.00% |
| Pecosil ™ PS100 | 0.50% |
| Sodium hydroxide | q.s. for pH = 9 |
| Titanium dioxide | 3.50% |
| Talc | 1.00% |
| Yellow iron oxide | 0.41% |
| Red iron oxide | 0.15% |
| Black iron oxide | 0.025% |

Phase B

| | |
|---|---|
| Montanov ™ L | 2.00% |
| Lanol ™ 99 | 4.00% |
| Caprylic/capric triglyceride | 4.00% |

Phase C

| | |
|---|---|
| DC345 ™ | 2.00% |
| Xanthan gum | 0.30% |
| Magnesium aluminium silicate | 1.00% |

Phase D

| | |
|---|---|
| Water | q.s. for 100% |
| Tetrasodium EDTA | 0.05% |
| Micropearl ™ M305 + composition | 2.00% |
| of Example 2 (80%/20%) | |

Phase E

| | |
|---|---|
| Sepicide ™ HB | 0.50% |
| Sepicide ™ CI | 0.30% |
| Fragrance | 0.20% |

Method

The liquid compounds of phase A are mixed and then the pH is adjusted before the addition of the pigments; this pigment phase is milled with a bead mill.

Phase B is subsequently melted at 75° C.

The water is also brought to 75° C. before the addition of phase D and then of phase A.

Then phase C is added to phase B and this mixture is introduced into the hot aqueous phase before the activation of the emulsifier.

The emulsion is subsequently gradually cooled and the constituents of phase E are added at 30° C.

### EXAMPLE 16

### Tinted Cream Gel

Formulation

Phase A

| | |
|---|---|
| Water | 10.00% |
| Butylene glycol | 4.00% |
| PEG 400 | 4.00% |
| Pecosil ™ PS100 | 1.50% |
| Sodium hydroxide | q.s. pH = 7 |
| Titanium dioxide | 2.00% |
| Yellow iron oxide | 0.80% |
| Red iron oxide | 0.30% |
| Black iron oxide | 0.05% |

Phase B

| | |
|---|---|
| Lanol ™ 99 | 4.00% |
| Caprylic/capric triglyceride | 4.00% |
| DC345 ™ | 4.00% |
| Sepicide ™ HB | 0.30% |
| Fragrance | 0.20% |

Phase C

| | |
|---|---|
| Water | q.s. for 100% |
| Tetrasodium EDTA | 0.05% |
| Sepicontrol ™ A5 | 4.00% |
| Sepicide CI (imidazolidinylurea- | 0.20% |
| Seppic) | |

Phase D

| | |
|---|---|
| Micropearl ™ M100 + composition | 17.5% |
| of Example 3 | |

Method

The liquid compounds of phase A are mixed before the addition of the pigments and then this pigment phase A is milled with a bead mill.

Phase D is introduced with turbulent stirring into phase C. When the gel is formed and homogeneous, the fatty phase B is added and then, finally, the pigment paste A.

### EXAMPLE 17

### Antisun Emulsion of Water-Silicone Type

Formulation

Phase A

| | |
|---|---|
| DC5225C ™ | 20.00% |
| DC345 ™ | 10.00% |
| Sepicalm ™ VG | 3.00% |
| Titanium dioxide | 5.00% |
| Zinc oxide, Z-Cote ™ | 4.00% |
| Composition of Example 2 | 1.00% |
| Sepicide ™ HB | 0.30% |
| Fragrance | 0.05% |

Phase B

| Water | q.s. for 100% |
|---|---|
| Sepicide ™ CI | 0.20% |
| Glycerol | 5.00% |
| Sodium chloride | 2.00% |

Method

Phase A is prepared by mixing the silicones and the Sepicalm™ VG, by then dispersing the inorganic fillers with gentle stirring until they are completely wet and by then adding the preservative and the fragrance.

The aqueous phase B is prepared separately and is then slowly introduced into phase A with moderate stirring. The homogenization stage begins after the introduction of all the components.

The characteristics of the commercial products used in the preceding examples are as follows:

Micropearl™ M305: silky water-dispersible powder based on crosslinked poly(methyl methacrylate);

Micropearl™ M310: silky hydrophobic powder based on crosslinked poly(methyl methacrylate);

Micropearl™ M100: silky water-dispersible powder based on poly(methyl methacrylate);

Micropearl™ M201: silky water-dispersible powder based on crosslinked poly(methyl methacrylate) with a particle size of approximately 1 to 5 μm;

Micropearl™ MHB: silky hydrophobic powder based on crosslinked poly(methyl methacrylate);

Simulgel™ EG: self-invertible inverse latex of copolymer, such as those disclosed in the international publication WO 99/36445 (INCI name: sodium acrylate/sodium acryloyldimethyl taurate copolymer and isohexadecane and polysorbate 80), sold by Seppic;

Simulgel™ NS: self-invertible inverse latex of copolymer, such as those disclosed in the international publication WO 99/36445 (INCI name: hydroxyethyl acrylate/sodium acryloyldimethyl taurate copolymer and squalane and polysorbate 60), sold by Seppic;

Sepigel™ 305: self-invertible inverse latex (INCI name: polyacrylamide/C13-14 isoparaffin/laureth-7);

DC5225C™: mixture of cyclopentasiloxane and of dimethicone copolyol, sold by Dow Corning;

DC345™: cyclomethicone, sold by Dow Corning;

Dry Flo™: starch modified with aluminium and octenyl succinate, sold by National Starch;

Mica 1000™: mica powder, sold by Sciama;

Aerosil™ 200: silica, sold by Degussa;

ZnO Neutral™: micronized zinc oxide, sold by Haarmann & Reimer;

Sepicide™ CI: imidazolidinylurea (preservative), sold by Seppic;

Sepicide™ HB: mixture of phenoxyethanol, of methylparaben, of ethylparaben, of propylparaben and of butylparaben (preservative), sold by Seppic;

Sepicide™ LD: phenoxyethanol, sold by Seppic;

Sensiva™ SC50: 1-(2-ethylhexyl) glycerol, sold by Schuelke & Mayr;

Sepicalm™ VG: composition such as those disclosed in the international publication WO 99/45899 (INCI name: sodium palmitoyl proline and Nymphaea alba flower extract), sold by Seppic;

Sepilift™ DPHP: (INCI name: dipalmitoylhydroxyproline), sold by Seppic;

Sepitonic™ M3: mixture of magnesium aspartate, of copper gluconate and of zinc gluconate, sold by Seppic;

Givobio™ GCu: copper gluconate, sold by Seppic;

Lipacide™ UG: undecylenoylglycine, sold by Seppic;

Lipacide™ C8G: octanoylglycine, sold by Seppic;

Lanol™ 99: isononyl isononanoate, sold by Seppic;

Lanol™ 1688: cetearyl ethylhexanoate, sold by Seppic; Pecosil™ PS100 is dimethicone copolyol phosphate, sold by Phoenix;

Montanov™ L: emulsifying agent based on C₁₄-C₂₂ alcohol and on C₁₂-C₂₀ alkyl polyglycoside, such as those disclosed in European Patent Application EP 0 995 487;

Sepicontrol™ A5: mixture of capryloylglycine, of sarcosine and of Cinnamomum zeylanicum extract, sold by Seppic, such as those disclosed in the international publication WO 99/00109.

1. Composition in the form of an inverse latex, comprising an oil phase, an aqueous phase, at least one emulsifying agent of water-in-oil (W/O) type and at least one emulsifying agent of oil-in-water (O/W) type, comprising from 20% to 70% by weight and preferably from 25% to 50% by weight of a crosslinked anionic polyelectrolyte, characterized in that the said polyelectrolyte is a copolymer of partially or completely salified 2-methyl-2-[(1-oxo-2-propenyl)amino]-1-propanesulphonic acid polymerized with at least one neutral monomer and with optionally at least one monomer having a weak acid functional group, in which the molar proportion of partially or completely salified 2-methyl-2-[(1-oxo-2-propenyl)amino]-1-propanesulphonic acid monomer is less than 30% and is greater than or equal to 1%.

2. Composition as defined in claim 1, for which the monomer with a weak acid functional group is chosen from acrylic acid, methacrylic acid, itaconic acid, maleic acid or 3-methyl-3-[(1-oxo-2-propenyl)amino]butanoic acid, the said acids being partially or completely salified.

3. Composition as defined in claim 1, for which the neutral monomer is chosen from acrylamide, methacrylamide, dimethylacrylamide, 2-hydroxyethyl acrylate, 2,3-dihydroxypropyl acrylate, 2-hydroxyethyl methacrylate, 2,3-dihydroxypropyl methacrylate, diacetone acrylamide or an ethoxylated derivative, with a molecular weight of between 400 and 1000, of each of these esters.

4. Composition as defined in claim 1, in which the anionic polyelectrolyte is chosen from:
copolymers of acrylamide and of 2-methyl-2-[(1-oxo-2-propenyl)amino]-1-propanesulphonic acid which are partially or completely salified in the sodium salt form,
terpolymers of 2-methyl-2-[(1-oxo-2-propenyl)amino]-1-propanesulphonic acid partially or completely salified in the sodium salt form, of acrylic acid partially or completely salified in the sodium salt form, and of acrylamide.

5. Composition as defined in claim 1, in which the crosslinked anionic polyelectrolyte exhibits a molar proportion of 2-methyl-2-[(1-oxo-2-propenyl)amino]-1-propanesulphonic acid monomer of greater than or equal to 2% and of less than or equal to 20%.

6. Polymer powder, characterized in that it is obtained either by azeotropic distillation or by precipitation or by atomization of the composition as defined in claim 1.

7. Use of a composition as defined in claim 1 in preparing a cosmetic, dermopharmaceutical or pharmaceutical topical composition.

8. Concentrate intended for the preparation of topical compositions essentially comprising a mixture comprising:
from 5% to 80% by weight of at least one composition as defined in claim 1, and
from 20% to 95% of a cosmetically or pharmaceutically acceptable powder.

9. Composition as defined in claim 2, for which the neutral monomer is chosen from acrylamide, methacrylamide, dimethylacrylamide, 2-hydroxyethyl acrylate, 2,3-dihydroxypropyl acrylate, 2-hydroxyethyl methacrylate, 2,3-dihydroxypropyl methacrylate, diacetone acrylamide or an ethoxylated derivative, with a molecular weight of between 400 and 1000, of each of these esters.

10. Composition as defined in claim 2, in which the anionic polyelectrolyte is chosen from:
copolymers of acrylamide and of 2-methyl-2-[(1-oxo-2-propenyl)amino]-1-propanesulphonic acid which are partially or completely salified in the sodium salt form,
terpolymers of 2-methyl-2-[(1-oxo-2-propenyl)amino]-1-propanesulphonic acid partially or completely salified in the sodium salt form, of acrylic acid partially or completely salified in the sodium salt form, and of acrylamide.

11. Composition as defined in claim 3, in which the anionic polyelectrolyte is chosen from:
copolymers of acrylamide and of 2-methyl-2-[(1-oxo-2-propenyl)amino]-1-propanesulphonic acid which are partially or completely salified in the sodium salt form,
terpolymers of 2-methyl-2-[(1-oxo-2-propenyl)amino]-1-propanesulphonic acid partially or completely salified in the sodium salt form, of acrylic acid partially or completely salified in the sodium salt form, and of acrylamide.

12. Composition as defined in claim 2, in which the crosslinked anionic polyelectrolyte exhibits a molar proportion of 2-methyl-2-[(1-oxo-2-propenyl)amino]-1-propanesulphonic acid monomer of greater than or equal to 2% and of less than or equal to 20%.

13. Composition as defined in claim 3, in which the crosslinked anionic polyelectrolyte exhibits a molar proportion of 2-methyl-2-[(1-oxo-2-propenyl)amino]-1-propanesulphonic acid monomer of greater than or equal to 2% and of less than or equal to 20%.

14. Composition as defined in claim 4, in which the crosslinked anionic polyelectrolyte exhibits a molar proportion of 2-methyl-2-[(1-oxo-2-propenyl)amino]-1-propanesulphonic acid monomer of greater than or equal to 2% and of less than or equal to 20%.

15. Concentrate intended for the preparation of topical compositions essentially comprising a mixture comprising:
from 5% to 80% by weight of at least one composition as defined in claim 2, and
from 20% to 95% of a cosmetically or pharmaceutically acceptable powder.

16. Concentrate intended for the preparation of topical compositions essentially comprising a mixture comprising:
from 5% to 80% by weight of at least one composition as defined in claim 3, and
from 20% to 95% of a cosmetically or pharmaceutically acceptable powder.

17. Concentrate intended for the preparation of topical compositions essentially comprising a mixture comprising:
from 5% to 80% by weight of at least one composition as defined in claim 4, and
from 20% to 95% of a cosmetically or pharmaceutically acceptable powder.

18. Concentrate intended for the preparation of topical compositions essentially comprising a mixture comprising:
from 5% to 80% by weight of at least one composition as defined in claim 5, and
from 20% to 95% of a cosmetically or pharmaceutically acceptable powder.
